(19) United States
(12) Patent Application Publication
(10) Pub. No.: US 2007/0259079 A1
(43) Pub. Date: Nov. 8, 2007

(54) COMPOSITIONS COMPRISING COLOR STABLE BETA CAROTENE

(75) Inventors: Per Anders Pihlsgard, New York, NY (US); Renee Hamaoui, Hartsdale, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Stokely-Van Camp, Inc., Chicago, IL (US)

(21) Appl. No.: 11/743,963

(22) Filed: May 3, 2007

Related U.S. Application Data
(60) Provisional application No. 60/797,217, filed on May 3, 2006.

(51) Int. Cl. A23L 1/27

(52) U.S. Cl. 426/250

(57) ABSTRACT

The subject invention provides a method for producing color stable suspensions comprising beta carotene. Such color stable suspensions are useful in any situation where the color of beta carotene is desirable, e.g., in beverages, foods, cosmetics, personal care products, pharmaceuticals, etc. The method comprises the steps of providing an aqueous beta carotene suspension, heating the beta carotene suspension to a heating temperature, and conditioning the beta carotene suspension by incubating the beta carotene suspension below the heating temperature for a period of time at one or more temperatures within an incubation temperature range sufficient to render the beta carotene suspension substantially color stable upon being cooled below the incubation temperature range.

### CROSS-REFERENCED APPLICATIONS

This application claims the priority benefit of U.S. Provisional Application No. 60/797,217, filed May 3, 2006 by Per Pihlsgard, et al.

### FIELD OF INVENTION

The invention relates to the field of food and beverage coloring.

### BACKGROUND

Beta carotene is a member of a family of chemicals known as the carotenoids, which are found in many fruits and vegetables, as well as some animal products such as egg yolks. Natural extracts containing carotenoids, for example carrot extracts and red palm oil, have been used to color foods for centuries. Carotenoids were first isolated in the early 19th century, and have been synthesized for use as food colorings since the 1950s. The structure of beta carotene is:

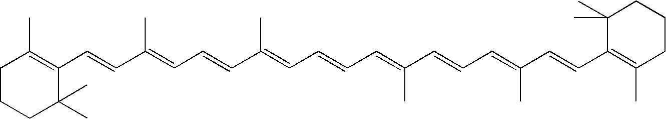

Beta carotene is used in foods and beverages to provide color. For example, it is commonly used in margarine to provide its yellow color. In addition, beta carotene may be used in foods or beverages for its anti-oxidant effects. Because the body metabolizes beta carotene into Vitamin A, it is also added to foods or beverages as a nutrient.

Current processes for incorporating carotenoids into water-based beverages or foods involve the use of organic solvents, oils with emulsifiers, high heating, or high-shear mixing. Used in low dosages, these beta carotene emulsions impart a transparent yellow color suitable for water beverages. Beta carotene as a coloring agent is used at various concentrations, for example, from 0.1 to 25 parts per million, including 1, 10 and 25 parts per million.

It has been surprisingly found that suspensions of beta carotene, when subjected to cooling (e.g., placed on ice or refrigerated), undergo a change in color, becoming a darker shade, e.g., a light orange suspension will become dark orange. A method of producing a color stable suspension of beta carotene is desirable.

### SUMMARY OF THE INVENTION

The subject invention provides a method for producing color stable suspensions comprising beta carotene. Such color stable suspensions are useful in any situation where the color of beta carotene is desirable, e.g., in beverages, foods, cosmetics, personal care products, pharmaceuticals, etc.

Certain aspects of the invention are directed to a method comprising the steps of incubating an aqueous medium comprising beta carotene in suspension for a period of time and at a temperature sufficient to condition the suspension such that when the suspension is cooled for from about 15 minutes to about 4 hours, it substantially retains the color the suspension had prior to cooling.

In certain exemplary embodiments, a method of making a color stable suspension comprising beta carotene is provided. The method comprises the steps of providing an aqueous beta carotene suspension, heating the beta carotene suspension to a heating temperature, and conditioning the beta carotene suspension by incubating the beta carotene suspension below the heating temperature for a period of time at one or more temperatures within an incubation temperature range sufficient to render the beta carotene suspension substantially color stable upon being cooled below the incubation temperature range.

Other aspects of the invention are directed to methods for making a color stable beverage or food comprising a beta carotene suspension. These methods comprise the steps of providing an aqueous beta carotene suspension, mixing the beta carotene suspension with other beverage or food components to form a beverage or food, heating the beverage or food to a heating temperature, and conditioning the beta carotene suspension by incubating the beverage or food below the heating temperature for a period of time at one or more temperatures within an incubation temperature range sufficient to render the beverage substantially color stable upon being cooled below the incubation temperature range.

In certain exemplary embodiments, a method of making a color stable beverage comprising a beta carotene suspension is provided. The method comprises the steps of providing a beta carotene suspension, mixing the beta carotene suspension for no more than 30 minutes with other beverage components to form a beverage, carrying out an aseptic packaging process comprising pasteurizing the beverage and filling at least one container with the beverage, and conditioning the beta carotene suspension by incubating the beverage after the filling step for 1-2 days at one or more temperatures between 60° F. and 80° F. (16°-27° C.), such that the beta carotene suspension is substantially color stable upon being cooled to a temperature between 32° F. and 45° F. (0°-7° C.).

Other aspects of the invention are directed to a color stable suspension comprising an aqueous medium comprising beta carotene in suspension. The color stable suspension is produced by heating the beta carotene suspension to a heating temperature, and then conditioning by incubating the beta carotene suspension below the heating temperature for a period of time at one or more temperatures within an incubation temperature range sufficient to render the beta carotene suspension substantially color stable upon being cooled below the incubation temperature range.

### DETAILED DESCRIPTION OF THE INVENTION

A beta carotene suspension comprises beta carotene dispersed in an aqueous medium. A beta carotene suspension can comprise some beta carotene in solution. It has been discovered that beta carotene in suspension may undergo an undesirable change in color when cooled to below ambient room temperatures, e.g., to 32° F.-45° F. (0°-7° C.); 32° F.-40° F. (0°-4° C.); or 32° F. to 35° F. (0°-2° C.). It is an object of the invention to provide a method of conditioning the beta carotene in suspension such that when cooled to below ambient room temperature, it retains substantially the same color as it had prior to being cooled. As used herein, “color stable” refers to a composition that retains substantially the same color upon cooling as it had prior to cooling or the same color as a sample not subjected to cooling. The phrase “color stable” is used to refer to the color of the aqueous medium as a whole (e.g., a completed beverage) or the just the color of the beta carotene component of the aqueous medium. Change in color can be determined by any method known to those of skill in the art, e.g., by visual inspection, spectrophotometer, or by a calorimeter. In one embodiment, the color change is measured by visually comparing the color of the cooled product to that of the product prior to cooling or to that of a sample not subjected to cooling. In another embodiment, a spectrophotometer, e.g., a Hunter Associates Lab Color Quest XE, is used to measure color change. In particular embodiments, the color is measured by using three color parameters: L (black/white), a (red/green), and b (yellow/blue). In one embodiment, the color of the cooled product is considered substantially the same when one or more of the color parameters selected from the group consisting of L, a and b vary by less than 50%, less than 40%, less than 35%, less than 30%, less than 20%, less than 10%, less than 5%, less than 2% or less than 1% from that of the product prior to cooling. In a preferred embodiment, the one or more color parameters selected from the group consisting of L, a and b vary by less than 35% or less than 30%. In a preferred embodiment, the color parameters are a and b. In other preferred embodiments, the color parameter is a or b. As used herein, “conditioning” refers to a process of making a composition color stable. In an embodiment of the invention, the beta carotene in suspension is a component of a beverage. In particular embodiments, the beverage further comprises one or more other components selected from the group consisting of sweeteners, flavoring agents, preservatives, coloring agents, salts, etc.

In an embodiment of the invention, beta carotene in suspension is subjected to a temperature for a duration of time such that when the beta carotene suspension is cooled to below ambient room temperature, it retains substantially the same color as it had prior to being cooled or the same color as a sample not subjected to cooling. In certain embodiments, the beta carotene is incubated at about 40° F.-95° F. (4°-35° C.); 45° F.-90° F. (7°-32° C.); 55° F.-90° F. (13°-32° C.); 65° F.-90° F. (180-32° C.); 75° F.-90° F. (24°-32° C.); 80° F.-90° F. (27°-32° C.); about 80° F. (27° C.); about 85° F. (29° C.); or about 90° F. (32° C.). In one embodiment, the incubation is for a duration of 0.5 to 4 days. In particular embodiments, after filling, the containers are incubated for 6 to 14 hours, 10 to 20 hours, 12 to 24 hours, 12 to 14 hours, 1 to 2 days; 36 to 48 hours; 40 to 48 hours; about 48 hours; or for 48 hours prior to cooling. One of skill in the art can determine whether the temperature/time combination is sufficient by cooling a sample of the beta carotene suspension to, e.g., 32° F.-45° F. (0°-7° C.) for 0.25 to 4 hours and comparing the color of the cooled beta carotene suspension to the color of a sample of the beta carotene suspension not subjected to cooling. If the color of the cooled beta carotene in suspension is substantially the same as the color of the sample not subjected to cooling, the temperature/time combination is sufficient.

In an embodiment of the invention, beta carotene in suspension is mixed for a limited period of time to enhance the color stability of the beta carotene. During, for example, production of a beverage, agitation or mixing is commonly used to produce a uniform product. In particular embodiments, the time that the beta carotene in suspension is exposed to mixing or agitation is limited to 90 minutes, 60 minutes, 45 minutes, 30 minutes, or 20 minutes. In preferred embodiments, the aqueous medium comprising beta carotene in suspension is mixed or agitated for about 20 minutes, for about 30 minutes, for 20 minutes, or for 30 minutes. Methods including longer mixing or agitation times are also contemplated, particularly when the beta carotene is added to the aqueous media for only a portion of the total mixture or agitation time. For example, in one embodiment, the components of a beverage except for the beta carotene are added together to an aqueous medium and mixed for a period of time, then the beta carotene is added to the medium and mixing continues for 90 minutes, 60 minutes, 45 minutes, 30 minutes, or 20 minutes.

Methods provided herein can be applied to any packaging process in which beta carotene is used and color stability of the beta carotene is desired. For example, both hot fill and aseptic processes can be modified to include the subject method. The methods of the invention are particularly suitable for products containing beta carotene in suspension wherein the product is cooled to below normal room temperature, e.g., by placing it in a refrigerator, on ice, or placing ice in the product. Under such cooling conditions, beta carotene that has not been conditioned according to the present methods may substantially change color, becoming darker. The methods of the invention include adjustment of times and temperature of existing packaging processes so as to allow for the conditioning of the beta carotene suspension during the packaging process. In an embodiment, increasing temperatures or times of one or more steps of the packaging process are used to ensure conditioning of the beta carotene suspension during the packaging process. In other embodiments, additional steps are added to existing packaging processes to condition the beta carotene in suspension, for example, by adding an incubation step in which the beta carotene in suspension is subjected to a temperature/duration combination sufficient to render the product substantially color stable upon cooling.

### Hot Fill Methods

In the hot-fill process, the medium (the product to be packaged) is heated to about 180° F.-210° F. (820-99° C.) to kill any bacteria present in the medium. A container is then filled with the heated medium and the container is capped while the medium is still hot. The container is then immediately cooled by any manner known in the art, such as by passage of the container through a cold water bath or a cooling tunnel.

When the medium contains beta carotene in suspension, this hot fill process may be modified to include the subject method of conditioning the beta carotene suspension such that upon cooling, the beta carotene in the medium retains substantially the same color as it had prior to cooling. In certain embodiments, the beta carotene in suspension substantially retains its original color, while the color of the medium changes color due to color changes to components other than the beta carotene. In other embodiments, the color of the medium is substantially the same after cooling as it was prior to cooling. In one embodiment, the beta carotene is conditioned before filling the container with the medium containing the beta carotene. In particular embodiments, this “pre-filling” conditioning is performed by keeping the beta carotene in suspension for 0.5 to 24 hours before filling the container with the medium containing the beta carotene in suspension; in particular embodiments the beta carotene is in suspension for 2 to 20 hours before filling; 4 to 16 hours before filling; 10 to 15 hours before filling; 12-14 hours before filling the container with the medium containing beta carotene in suspension; about 12 hours; about 14 hours; 12 hours; or 14 hours is preferred. The duration of the pre-filling conditioning is measured by the time elapsed from when the beta carotene is placed in suspension until the media containing the beta carotene in suspension is filled into a container. This pre-filling conditioning can be carried out at any temperature, preferably from about 40° F.-95° F. (40-35° C.); 45° F.-90° F. (70-32° C.); 55° F.-90° F. (130-32° C.); 65° F.-90° F. (18°-32° C.); 75° F.-90° F. (24°-32° C.); 80° F.-90° F. (27°-32° C.); about 80° F. (27° C.); about 85° F. (29° C.); or about 90° F. (32° C.). In particular embodiments, the beta carotene is suspended in a solution that is within the range of the previously recited temperatures, and the suspension is allowed to cool over time, so that the pre-filling conditioning takes place at a temperature that drops over time.

In another embodiment, post-filling conditioning is carried out. In one embodiment, such post-filling conditioning is performed by incubating the filled and capped containers for 6 hours to 4 days prior to cooling. In particular embodiments, after filling, the containers are incubated for 6 to 14 hours, 10 to 20 hours, 12 to 24 hours, 12 to 14 hours, 1 to 2 days; 36 to 48 hours; 40 to 48 hours; about 48 hours; or for 48 hours prior to cooling. In particular embodiments, such incubation is performed at room temperature; 50° F.-90° F. (10°-32° C.); 60° F.-80° F. (16°-27° C.); 65° F.-75° F. (180-24° C.); about 65° F. (18° C.); about 70° F. (21° C.); or about 75° F. (24° C.).

In one embodiment, both pre-filling and post-filling conditioning are utilized. Any combination of the above temperatures and times are used, such that the color of the medium is substantially the same after cooling as it was prior to cooling and/or the color of the beta carotene in suspension is substantially the same after cooling as it was prior to cooling.

### Aseptic Methods

In the aseptic process, the medium is heated to about 180° F.-210° F. (820-99° C.) to kill any bacteria present in the medium. The medium is then cooled to about 80° F.-110° F. (27°-43° C.). The container and its closure are sterilized and then the containers are filled and capped in a sterile environment. Once the containers are filled and capped, they are typically cooled.

When the medium contains beta carotene in suspension, this aseptic fill process is modified to include the subject method of conditioning the beta carotene suspension such that upon cooling, the beta carotene in the medium retains substantially the same color as it had prior to cooling. In certain embodiments, the beta carotene in suspension substantially retains its original color, while the color of the medium changes color due to color changes to components other than the beta carotene. In other embodiments, the color of the medium is substantially the same after cooling as it was prior to cooling. In one embodiment, the beta carotene is conditioned before filling the container with the medium containing the beta carotene. In particular embodiments, this “pre-filling” conditioning is performed by keeping the beta carotene in suspension for 0.5 to 24 hours before filling the container with the medium containing the beta carotene in suspension; in particular embodiments the beta carotene is in suspension for 2 to 20 hours before filling; 4 to 16 hours before filling; 10 to 15 hours before filling; 12-14 hours before filling the container with the medium containing beta carotene in suspension; about 12 hours; about 14 hours; 12 hours; or 14 hours is preferred. The duration of the pre-filling conditioning is measured by the time elapsed from when the beta carotene is placed in suspension until the media containing the beta carotene in suspension is filled into a container. This pre-filling conditioning can be carried out at any temperature, preferably from about 40° F.-95° F. (4°-35° C.); 45° F.-90° F. (7°-32° C.); 55° F.-90° F. (13°-32° C.); 65° F.-90° F. (18°-32° C.); 75° F.-90° F. (24°-32° C.); 80° F.-90° F. (270-32° C.); about 80° F. (27° C.); about 85° F. (29° C.); or about 90° F. (32° C.). In particular embodiments, the beta carotene is suspended in a solution that is within the range of the previously recited temperatures, and the suspension is allowed to cool over time, so that the pre-filling conditioning takes place at a temperature that drops over time.

In another embodiment, post-filling conditioning is carried out. In one embodiment, such post-filling conditioning is performed by incubating the filled and capped containers for 0.5 to 4 days prior to cooling. In particular embodiments, after filling, the containers are incubated for 6 to 14 hours, 10 to 20 hours, 12 to 24 hours, 12 to 14 hours, 1 to 2 days; 36 to 48 hours; 40 to 48 hours; about 48 hours; or for 48 hours prior to cooling. In particular embodiments, such incubation is performed at room temperature. In particular embodiments, such incubation is performed at room temperature; 50° F.-90° F. (10°-32° C.); 60° F.-80° F. (16°-27° C.); 65° F.-75° F. (18°-24° C.); about 65° F. (18° C.); about 70° F. (21° C.); or about 75° F. (24° C.).

In one embodiment, both pre-filling and post-filling conditioning are utilized. Any combination of the above temperatures and times are used, such that the color of the medium is substantially the same after cooling as it was prior to cooling and/or the color of the beta carotene in suspension is substantially the same after cooling as it was prior to cooling.

### EXAMPLES

The examples which follow are set forth to aid in understanding the invention but are not intended to and should not be construed to limit its scope in any way.

### Example 1

The following aseptic process is used to produce a color stable beverage comprising beta carotene as the primary coloring agent. The resulting beverage retains its color when cooled.

Beta Carotene 10% (CWS)

Beta carotene is purchased from DSM as red beadlets containing not less than 100 mg/g beta carotene in a matrix of sucrose, fish gelatin, food starch and peanut oil. Beta carotene beadlets are readily dispersible in water with stirring. One gram of beta carotene beadlets contains 167,000 LU. of provitamin A activity. Ascorbic palmitate and dl-tocopherol are added to this ingredient as antioxidants.

Beverage Process

The following process is adjusted for the total amount of ingredients depending on the particular beverage being produced and the amount of said beverage.
1. Add 2-5% of the total amount of water to be used in the process at 55°-120° F. (13°-49° C.) into sugar dissolution tank.
2. Begin agitation
3. Dissolve sucrose granulated into sugar dissolution tank.
4. Agitate until mixed.
5. Transfer simple syrup from sugar dissolution tank through filter (30 microns or less) to beverage tank.
6. Begin agitation.
7. Add glucose syrup to beverage tank.
8. Agitate until mixed.
9. Add remaining water at 55°-90° F. (13°-32° C.) into beverage tank.
10. Agitate until mixed.
11. Dissolve beta carotene 10% Cold Water Soluble (CWS) into beverage tank. The amount will vary depending on the color required, for example, from 0.005% to 0.02% of the water weight (w/w). The beta carotene is kept in suspension for a minimum of 30 minutes prior to the filling step.
12. Agitate until mixed.
13. Dissolve beverage base into beverage tank.
14. Dissolve any other dry ingredients for the particular beverage being produced into beverage tank.
15. Agitate until mixed.
16. Add flavor to beverage tank.
17. Agitate for a maximum of 5 minutes.
18. Hold finished beverage for 12 to 14 hours prior to thermal processing and filling.
19. Agitate for 60 seconds once every 1 hour(s) during storage before thermal processing and filling.
20. Process beverage in accordance with thermal process specifications:

| Thermal Process Parameter | Value |
|---|---|
| Product temperature at hold tube exit | 202.0° F. (94.4° C.) to |
| | 205.5° F. (96.4° C.) |
| Hold time prior to entrance to product | 30.0 seconds to 33.0 seconds |
| cooler | |
| Product temperature at product cooler exit | 90° F. (32° C.) to |
| | 105.1° F. (40.6° C.) |

21. Screen finished beverage through a 10 micron bag filter prior to filling
22. Fill beverage.
23. Hold in bottle at room temperature 77° F. (25° C.) or higher for 24 hours.

### Example 2

The following experiments were performed to determine several sets of conditions suitable for the production of a beverage comprising color stable suspensions of beta carotene.
1. Mixing
   i. Mixing Type: Automatic stirrers inside of the 4000 gallon batch tank.
   ii. Mixing Time
      1. Filling the Batch Tank: Initially a 15.14 m³ tank (4000 gal) is filled with water at 30° C., sucrose syrup and glucose syrup. All three liquids are added from the top of the tank via hard piping (exclusive for each stream). Adding liquids from the top of the tank generate turbulence and mixing. In addition to this mixing, the batching tank has an overhead standard mixer. Agitation begins when liquid volume reaches 5 m³. For our batch, at time 1.5 minutes agitation begins
      2. Adding Dry Ingredients: Beta carotene was added at 1.5 minutes while water, sucrose syrup and glucose syrup were still being added to the tank. At time=m 4 minutes 10 seconds the other ingredients were added. All dry ingredients were added to the batch tank while liquids were still being delivered. Beta carotene was in contact with the batch (and therefore water for hydration) for a total of 32 minutes.
      3. Transferring to line: While waiting to be transferred to the thermal process, the batch is kept agitating through the following cycle: 40 seconds of agitation then 5 minutes of no agitation. The batch was transferred at time=37 minutes.
      4. Total estimated Agitation: 37 minutes of total agitation; 35 minutes of agitation from Beta Carotene; water temperature was 86° F. (30° C.).
2. Aseptic Process
   i. Pasteurized at 205.7° F. (96.5° C.) and then filled at 77° F. (25° C.).
   ii. Held at 205.7° F. (96.5° C.) for 30 to 33 seconds.
   iii. In bottle temperature was approximately 77° F. (25° C.).
3. Color Stability After In Bottle Conditioning
   i. Failure (Color change and variation, leading to sedimentation.)
      1. No conditioning, bottles placed directly into 40° F. (4° C.); took about 4 hours.
   ii. Success (No color change, extended shelf life.)
      1. 24 hours at room temperature, then put into 40° F. (4° C.).

### Example 3

The following experiments were performed to determine several sets of conditions suitable for the production of a beverage comprising color stable suspensions of beta carotene.
1. Mixing
   i. Mixing Type: Pneumatic stirrers inside of the 300 gallon batch tank.
   ii. Mixing Time
      1. Batching: While adding the ingredients flavors and prior to sending over to the thermal processing the tank is agitated for a total of 30 minutes. This includes adding the syrups, dry ingredients, flavor, and checking the specifications.
      2. Filling: While filling the batch, the 300 gallon tank is put through the same Silea cycle to properly simulate the process. The cycle is as follows: 40 seconds of agitation then 5 minutes of no agitation. The batch will go through this cycle about 4 times, accumulating approximately 2.5 minutes of agitation.
      3. Total estimated agitation: 30 min+2.5 min=32.5 minutes of agitation.
2. Processing Equipment
   i. Pumps:
      1. Number: 4 pumps
      2. Type: Centrifugal Pumps, 1750 rpm
   ii. Filling Line:
      1. Number of Valves: 18 valves
      2. Line Speed: 60 Bottles per Minute (20 ounce Gatorade)
      3. Type of Filler: US Bottler Filler—Pressure Gravity Filler
      4. Hot fill and Simulated Aseptic Processed
         a. The product was pasteurized at 193.5° F. (89.7° C.) for 30 seconds.
         b. Filled into bottle at 175° F. (79° C.), inverted to ensure micro stability.
         c. To simulate an aseptic process, bottles were submerged into an ice bath for approximately 4 minutes, bringing the product to ambient room temperature.
3. Color Stability After In Bottle Conditioning
   i. Failure (Color change and variation, leading to sedimentation.)
      1. No time at room temperature, put directly into ice bath—severe color change
      2. No time at room temperature, put directly into 40° F. (4° C.)—color change
      3. 24 hours at room temperature (70° F.) (21° C.) then put into 40° F. (4° C.)—Color change within 48 hours
      4. 48 hours at room temperature (70° F.) (21° C.) then put into 40° F. (4° C.)—Slight color change within 54 hours
   ii. Success (No color change, extended shelf life.)
      1. 72 hours at room temperature (70° F.) (21° C.), put into 40° F. (4° C.)—No color change
      2. Stored at 70° F. (21° C.)—No color change
      3. Stored at 90° F. (32° C.)—No color change

### Example 4

The following experiments were performed to determine several sets of conditions suitable for the production of a beverage comprising color stable suspensions of beta carotene.
1. Mixing
   i. Type: Electric stirrers inside of the 20 liter container.
   ii. Temperature: 60° F. (16° C.)
   iii. Time: Various mixing times were tested to see if the outcome would be different.
      1. 30 minutes agitation while batching.
      2. 60 minutes agitation while batching
      3. 90 minutes agitation while batching
      4. 20/40 agitation—20 minutes agitation beta carotene alone followed by 20 minutes of the entire mixture, total of 40 minutes hydration before filling.
2. Processing Equipment
   i. Pumps:
      1. One pump
      2. Type: Progressive Cavity pump
   ii. Filling Line:
      1. Number of Valves: 1 valve
      2. Line Speed: 1 liter per minute
      3. Type of Filler: Microthermics
      4. Simulated Aseptic Processed:
         a. Pasteurized at 202° F. (94° C.) and then filled at 75° F. (24° C.) using microthermics equipment.
         b. Hold time for pasteurization was 30 seconds and cooling down to 75° F. (24° C.) was done through the HTST (high temperature short time) processing method.
         c. Bottles and caps were rinsed in hot water prior to filling, but package was not sterile.
3. Color Stability After In Bottle Conditioning
   i. 30 minute agitation
      1. Failure
      a. No time at room temperature, put directly into 40° F. (4° C.)—Color shift.
      2. Success
         a. 24 hours at room temperature (70° F.) (21° C.) then put into 40° F. (4° C.)—No color change
         b. 48 hours at room temperature (70° F.) (21° C.) then put into 40° F. (4° C.)—No color change
         c. 72 hours at room temperature (70° F.) (21° C.) then put into 40° F. (4° C.)—No color change
   ii. 60 minute agitation
      1. Failure
         a. No time at room temperature, put directly into 40° F. (4° C.)—Color shift,
      2. Success
         a. 24 hours at room temperature (70° F.) (21° C.) then put into 40° F. (4° C.)—No color change
         b. 48 hours at room temperature (70° F.) (21° C.) then put into 40° F. (4° C.)—No color change
         c. 72 hours at room temperature (70° F.) (21° C.) then put into 40° F. (4° C.)—No color change
   iii. 90 minute agitation
      1. Failure
         a. No time at room temperature, put directly into 40° F. (4° C.)—Color shift
      2. Success
         a. 24 hours at room temperature (70° F.) (21° C.) then put into 40° F. (4° C.)—No color change
         b. 48 hours at room temperature (70° F.) (21° C.) then put into 40° F. (4° C.)—No color change
         c. 72 hours at room temperature (70° F.) (21° C.) then put into 40° F. (4° C.)—No color change
   iv. 20/40 agitation
      1. Failure
         a. No time at room temperature, put directly into 40° F. (4° C.)—Color shift
      2. Success
         a. 24 hours at room temperature (70° F.) (21° C.) then put into 40° F. (4° C.)—No color change
         b. 48 hours at room temperature (70° F.) (21° C.) then put into 40° F. (4° C.)—No color change
         c. 72 hours at room temperature (70° F.) (21° C.) then put into 40° F. (4° C.)—No color change
4. Conclusions Regarding Color Shift
   i. When put into the 40° F. (4° C.) environment initially there was a variation in color shift. The 20/40 and 30 minute agitation samples had the least color shift, where the 60 minute agitation samples had a stronger color shift, and then 90 minute agitation sample had the greatest color shift. Increased agitating time caused more of a shift of color.
   ii. After 24 hours at room temperature, none of the samples changed color.

All references cited herein are incorporated herein by reference in their entirety and for all purposes to the same extent as if each individual publication or patent or patent application was specifically and individually indicated to be incorporated by reference in its entirety for all purposes.

Many modifications and variations of the present invention can be made without departing from its spirit and scope, as will be apparent to those skilled in the art. The specific embodiments described herein are offered by way of example only, and the invention is to be limited only by the terms of the appended claims along with the full scope of equivalents to which such claims are entitled.

The foregoing descriptions comprise illustrative embodiments of the present inventions. The foregoing embodiments and the methods described herein may vary based on the ability, experience, and preference of those skilled in the art. Merely listing the steps of the method in a certain order does not necessarily constitute any limitation on the order of the steps of the method. The foregoing description merely explains and illustrates the invention, and the invention is not limited thereto, except insofar as the claims are so limited. Those skilled in the art who have the disclosure before them will be able to make modifications and variations therein without departing from the scope of the invention.

What is claimed is:

1. A method of making a color stable suspension comprising beta carotene, comprising the steps of:
providing an aqueous beta carotene suspension;
heating the beta carotene suspension to a heating temperature; and
conditioning the beta carotene suspension by incubating the beta carotene suspension below the heating temperature for a period of time at one or more temperatures within an incubation temperature range sufficient to render the beta carotene suspension substantially color stable upon being cooled below the incubation temperature range.

2. A method of making a color stable beverage comprising a beta carotene suspension, comprising the steps of:
providing an aqueous beta carotene suspension;
mixing the beta carotene suspension with other beverage components to form a beverage;
heating the beverage to a heating temperature; and
conditioning the beta carotene suspension by incubating the beverage below the heating temperature for a period of time at one or more temperatures within an incubation temperature range sufficient to render the beverage substantially color stable upon being cooled below the incubation temperature range.

3. A method of making a color stable food comprising a beta carotene suspension, comprising the steps of:
providing an aqueous beta carotene suspension;
mixing the beta carotene suspension with other food components to form a food;
heating the food to a heating temperature; and
conditioning the beta carotene suspension by incubating the food below the heating temperature for a period of time at one or more temperatures within an incubation temperature range sufficient to render the food substantially color stable upon being cooled below the incubation temperature range.

4. The method of claim 1, wherein the heating temperature is sufficient to pasteurize the beta carotene suspension.

5. The method of claim 1, wherein the heating temperature is within the range of 180° F.-210° F. (82°-99° C.).

6. The method of claim 1, wherein the incubating of the beta carotene suspension is sufficient to render the beta carotene suspension substantially color stable upon being cooled to below ambient room temperature.

7. The method of claim 1, wherein the incubating of the beta carotene suspension is sufficient to render the beta carotene suspension substantially color stable upon being cooled to below 45° F. (7° C.).

8. The method of claim 1, wherein the incubating of the beta carotene suspension is sufficient to render the beta carotene suspension substantially color stable upon being cooled to a temperature within the range of 32° F.-40° F. (0°-4° C.).

9. The method of claim 1, wherein the incubation temperature range is greater than 55° F. (13° C.).

10. The method of claim 1, wherein the incubation temperature range is within 55° F. to 90° F. (130-32° C.).

11. The method of claim 1, wherein the incubation temperature range is within 65° F. to 90° F. (180-32° C.).

12. The method of claim 1, wherein the incubation temperature range is within 80° F. to 90° F. (27°-32° C.).

13. The method of claim 1, wherein the incubating period of time is at least 0.5 days.

14. The method of claim 1, wherein the incubating period of time is 0.5 to 4 days.

15. A hot fill packaging process comprising the method of claim 1.

16. An aseptic packaging process comprising the method of claim 1.

17. The method of claim 1, further comprising the step of filling a portion of the beta carotene suspension into at least one container subsequent to the conditioning step.

18. The method of claim 1, further comprising the step of filling a portion of the beta carotene suspension into at least one container prior to the conditioning step.

19. The method of claim 17, wherein the incubating period of time is 0.5 to 24 hours.

20. The method of claim 17, wherein the incubating period of time is 12-14 hours.

21. The method of claim 18, wherein the incubating period of time is 6 hours to 4 days.

22. The method of claim 18, wherein the incubating period of time is 1-2 days.

23. The method of claim 1, wherein providing the beta carotene suspension comprises mixing for no more than 90 minutes.

24. The method of claim 1, wherein providing the beta carotene suspension comprises mixing for no more than 60 minutes.

25. The method of claim 1, wherein providing the beta carotene suspension comprises mixing for no more than 30 minutes.

26. A method of making a color stable beverage comprising a beta carotene suspension, comprising the steps of:
providing a beta carotene suspension;
mixing the beta carotene suspension for no more than 30 minutes with other beverage components to form a beverage;
carrying out an aseptic packaging process comprising pasteurizing the beverage and filling at least one container with the beverage; and
conditioning the beta carotene suspension by incubating the beverage after the filling step for 1-2 days at one or more temperatures between 60° F. and 80° F. (160-27° C.), such that the beta carotene suspension is substantially color stable upon being cooled to a temperature between 32° F. and 45° F. (0°-7° C.).

27. A color stable suspension comprising an aqueous medium comprising beta carotene in suspension, which has been heated to a heating temperature, and then conditioned by incubating the beta carotene suspension below the heating temperature for a period of time at one or more temperatures within an incubation temperature range sufficient to render the beta carotene suspension substantially color stable upon being cooled below the incubation temperature range.
